(19) United States
(12) Patent Application Publication
(10) Pub. No.: US 2015/0360334 A1
(43) Pub. Date: Dec. 17, 2015

(54) COMPACTION APPARATUS AND METHOD FOR HEAT EXCHANGE UNIT

(71) Applicant: JOSEPH COMPANY INTERNATIONAL, INC., Irvine, CA (US)

(72) Inventor: MARK SILLINCE, Rustington West Sussex (GB)

(73) Assignee: JOSEPH COMPANY INTERNATIONAL, INC., Irvine, CA (US)

(21) Appl. No.: 14/763,804

(22) PCT Filed: Jan. 29, 2014
(86) PCT No.: PCT/US14/13691

§ 371 Date: Jul. 27, 2015

Related U.S. Application Data
(60) Provisional application No. 61/758,643, filed on Jan. 30, 2013.

(51) Int. Cl. B23P 15/26

(52) U.S. Cl. CPC B23P 15/26

(57) ABSTRACT

A module defining a plurality of cavities adapted to receive adsorbent material and movable from a loading station to a compaction station and to a transfer station, a plurality of rams at the compaction station for exerting pressure on the adsorbent material to compact it and rams at the transfer station to extract the compacted adsorbent material from said cavities.

### FIELD OF THE INVENTION

The present invention relates generally to a heat exchange unit for use in containers for self-chilling foods or beverages and more particularly to the formation of compacted activated carbon for use in a heat exchange unit (HEU) of the type in which temperature reduction is caused by the desorption of a gas from the compacted activated carbon disposed within the heat exchange unit.

### DESCRIPTION OF THE ART

Many foods or beverages available in portable containers are preferably consumed when they are chilled. For example, carbonated soft drinks, fruit drinks, beer, puddings, cottage cheese and the like are preferably consumed at temperatures varying between 33° Fahrenheit (0.555° Celsius) and 50° Fahrenheit (10° Celsius). When the convenience of refrigerators or ice is not available such as when fishing, camping or the like, the task of cooling these foods or beverages prior to consumption is made more difficult and in such circumstances it is highly desirable to have a method for rapidly cooling the content of the containers prior to consumption. Thus a self-cooling container, that is, one not requiring external low temperature conditions is desirable.

The art is replete with container designs which incorporate a coolant capable of cooling the contents without exposure to the external low temperature conditions. The vast majority of these containers incorporate or otherwise utilize refrigerant gases which upon release or activation absorb heat in order to cool the contents of the container. Other techniques have recognized the use of endothermic chemical reactions as a mechanism to absorb heat and thereby cool the contents of the container. Examples of such endothermic chemical reaction devices are those disclosed in U.S. Pat. Nos. 1,897,723, 2,746,265, 2,882,691 and 4,802,343.

Typical of devices which utilize gaseous refrigerants are those disclosed in U.S. Pat. Nos. 2,460,765, 3,373,581, 3,636,726, 3,726,106, 4,584,848, 4,656,838, 4,784,678, 5,214,933, 5,285,812, 5,325,680, 5,331,817, 5,606,866, 5,692,381 and 5,692,391. In many instances the refrigerant gas utilized in a structure such as those shown in the foregoing U.S. Patents do not function to lower the temperature properly or if they do, they contain a refrigerant gaseous material which may contribute to the greenhouse effect and thus is not friendly to the environment.

To solve problems such as those set forth in the prior art, applicant is utilizing as a part of the present invention an adsorbent-desorbent system which comprises activated carbon which functions as an adsorbent for carbon dioxide. A system of this type is disclosed in U.S. Pat. No. 5,692,381 which is incorporated herein by reference.

In these devices the adsorbent material is disposed within a vessel, the outer surface of which is in contact thermally with the food or beverage to be cooled. Typically, the vessel is connected to an outer container which receives the food or beverage to be cooled in such a manner that it is in thermal contact with the outer surface of the vessel containing the adsorbent material. This vessel or heat exchange unit is affixed to the outer container, typically to the bottom thereof, and contains a valve or similar mechanism which functions to release a quantity of gas, such as carbon dioxide which has been adsorbed by the adsorbent material contained within the inner vessel. When opened the gas such as carbon dioxide is desorbed and the endothermic process of desorption of the gas from the activated carbon adsorbent causes a reduction in the temperature of the food or beverage which is in thermal contact with the outer surface of the inner vessel thereby lowering the temperature of the food or beverage contained therein.

To accomplish this cooling it is imperative that as much carbon dioxide as possible be adsorbed onto the carbon particles contained within the inner vessel and further that the thermal energy contained within the food or beverage be transferred therefrom through the wall of the inner vessel and through the adsorbent material to be carried out of the heat exchange unit along with the desorbed carbon dioxide gas. It is known in the art that most adsorbents are poor conductors of thermal energy. For example, activated carbon can be described as an amorphic material and consequently has a low thermal conductivity. By compacting the activated carbon to the maximum amount while still permitting maximum adsorption of the carbon dioxide gas thereon does assist in conduction of thermal energy.

It is important that the adsorbent material, such as the activated carbon particles, be compacted as highly as possible without substantially reducing the porosity of the body of adsorbent material to such a degree that its capability of adsorbing the carbon dioxide gas or the retardation of the rate of desorption from within the body of the adsorbent material is not deleteriously affected.

Preferably, the adsorbent material is activated carbon and the gas to be adsorbed is carbon dioxide. In the context of this disclosure, “activated carbon” relates to a family of carbonaceous materials specifically activated to develop strong adsorptive properties whereby even trace quantities of liquids or gases may be adsorbed onto the carbon. Such activated carbons may be produced from a wide range of sources, for example coal, wood, nuts (such as coconut) and bones and may be derived from synthetic sources, such as polyacrylonitrile. Various methods of activation exist, such as selective oxidation with steam, carbon dioxide or other gases at elevated temperatures or chemical activation using, for example, zinc chloride or phosphoric acid. The adsorbent also includes a graphite material in an amount 0.01 to 80% by weight of the total composition, and a binder material.

Any available form of graphite, natural or synthetic, may be incorporated into the activated carbon, for example powdered or flakes of graphite may be used. Preferably, graphite is included in an amount ranging from 10% to 50% by weight, more preferably 20% to 45% by weight, especially 40% by weight.

A binder material is included such as polytetrafluoroethylene, to enhance the green strength for of the formulation for handling thereof. A composition of activated carbon with graphite and a binder is disclosed in U.S. Pat. No. 7,185,511 which is incorporated herein by reference.

There is thus a requirement for apparatus and a method by which the adsorbent material including the graphite and binder can be compacted as highly as possible so as to increase the amount of carbon dioxide which can be adsorbed thereon.

### SUMMARY OF THE INVENTION

An apparatus for compacting an adsorbent material comprising a cavity within which a predetermined amount of uncompacted adsorbent material may be deposited, a first ram adapted to be inserted into the bottom of the cavity to support the adsorbent material, a second ram adapted to be inserted into the top of said cavity, means for applying pressure to said first and second rams to compact the adsorbent material therebetween, an additional ram to transfer the compacted carbon from the cavity into an HEU shell.

A method of compacting an adsorbent material comprising weighing the adsorbent material, depositing the adsorbent material into a cavity, inserting a ram into the cavity bottom, inserting a ram into the cavity top, applying pressure to the top ram to compact the adsorbent material, positioning an HEU can under the cavity, and transferring the compacted adsorbent material to the HEU can.

### BRIEF DESCRIPTION OF THE DRAWINGS

FIG. 1 is a schematic drawing illustrating a cavity and the compaction of adsorbent material therein;

FIG. 2 is a schematic diagram illustrating transferring compacted adsorbent material into an HEU can;

FIG. 3 is a flow diagram illustrating the method of the present invention;

FIG. 4 is a front elevational view of a four-cavity apparatus for compacting the adsorbent material and transferring the same to the HEU can;

FIG. 5 is a left side view of the structure shown in FIG. 4;

FIG. 6 is a top view thereof; and

FIG. 7 is a schematic drawing illustrating an alternative embodiment of a compaction apparatus.

### DETAILED DESCRIPTION

Referring now to FIG. 1, there is schematically illustrated a mechanism in the form of a block of metal material 12 which defines a cavity 14. The cavity 14 is adapted to receive a predetermined amount of the adsorbent material which as above described is preferably a composition of activated carbon, graphite and a binder which is shown generally at 16. The amount of material which is deposited within the cavity 14 is determined by the amount when compacted, as will be described more fully below, will be sufficient when placed within the HEU can to adsorb a sufficient quantity of carbon dioxide to accomplish a desired self-cooling of a food or beverage contained within a container within which the heat exchange unit (HEU) is situated. A first ram 18 is positioned internally at the bottom of the cavity 14 by appropriate force as illustrated by the arrow 20 such as that which would be applied by a hydraulic actuator. The ram 18 is positioned within the cavity 14 by a sufficient distance to support the adsorbent material 16 as it is being compacted.

A second ram 22 is inserted at the top of the cavity 14 and applies a force as shown by the arrow 24 which would be generated by an appropriate mechanism such as a hydraulic actuator or the like to compress the adsorbent material 16 by the desired amount, to assure that it is very highly compacted. The ram 22 also includes a piston-like member 26 which protrudes into the adsorbent material 16 to provide a cavity therein after it is compacted. The cavity is adapted to receive a portion of a valve which when activated will allow the gas, preferably carbon dioxide, to be desorbed from the adsorbent material when it is desired to cool food or beverage within the container housing the heat exchange unit. In addition, the utilization of the opening within the compacted adsorbent material also provides for additional surface area for adsorption of the carbon dioxide. It will be understood by those skilled in the art that the cavity thus provided may extend completely through the adsorbent material 16 if such is desired.

The amount of pressure which is applied between the two rams 18 and 22 to accomplish the desired compaction of the adsorbent material 16 creates a force of approximately 17 tons. It has been found that a force of this magnitude is required for each cavity to accomplish the desired compaction of the adsorbent material to provide the desired adsorption of a sufficient amount of the carbon dioxide to accomplish the desired cooling of the food or beverage that is housed within the container in contact with the HEU.

Once the desired compaction of the adsorbent material 16 has been accomplished, the two rams 18 and 22 are retracted from the cavity 14. When such occurs, there will be a natural expansion of the compacted adsorbent material, however, because of the distance within which the rams 18 and 22 extend into the cavity 14, the compacted carbon expansion can only be longitudinal, that is either up or down or both, as illustrated in FIG. 1 and it cannot laterally expand. It will be understood by those skilled in the art that the amount of expansion which occurs is relatively small but some expansion will naturally occur.

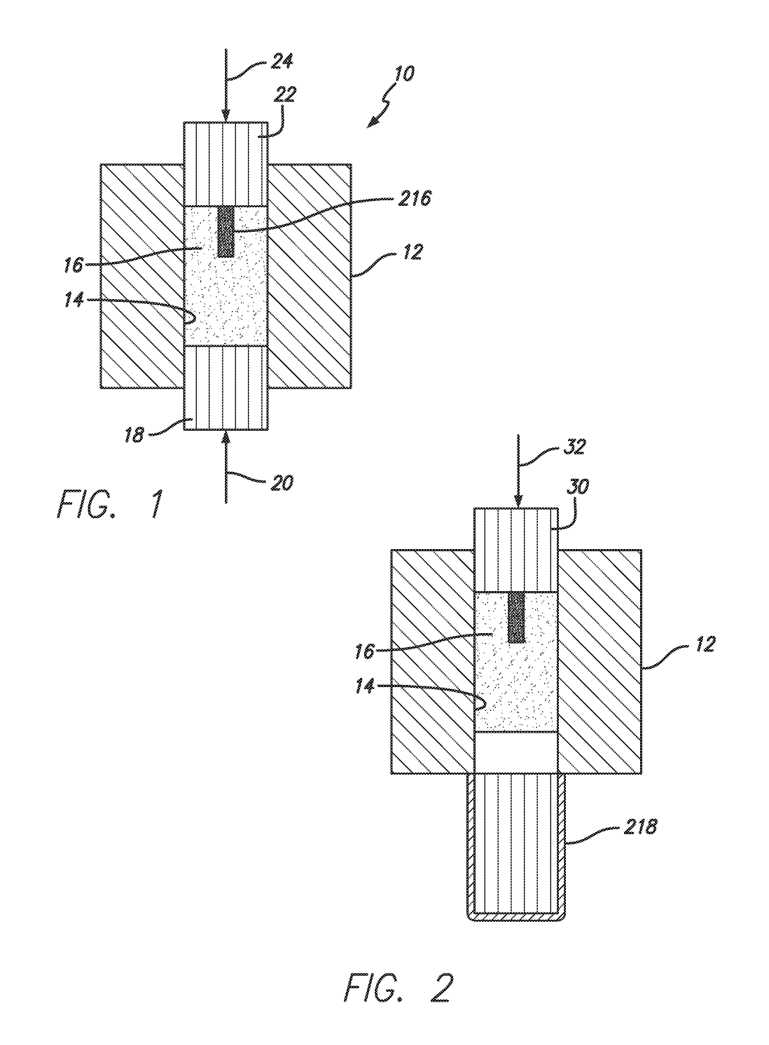

Referring now to FIG. 2, the compacted adsorbent material 16 as positioned within the cavity 14 now has an HEU can 28 positioned at the bottom of the cavity 14 appearing in the block of material 12. The HEU can 28 is of sufficient volume and dimension that it is capable of receiving the compacted adsorbent material 16. As a result an additional ram 30 has a small amount of pressure applied thereto as shown by the arrow 32 so that it will move the compacted adsorbent material 16 downwardly out of the cavity 14 and into the interior of the HEU can 28. A sufficient amount of force is applied to the ram 30 to be sure that the compacted adsorbent material 16 is firmly seated against the bottom of the HEU can 28 but does not damage the adsorbent material or the HEU can. Once such occurs the ram 30 is removed and the HEU can 28 with the compacted absorbent material firmly seated therein is removed and is transported to a desired position for inclusion within a container for receiving the food or beverage to be cooled as is more fully described in the patents incorporated herein by reference and above referred to.

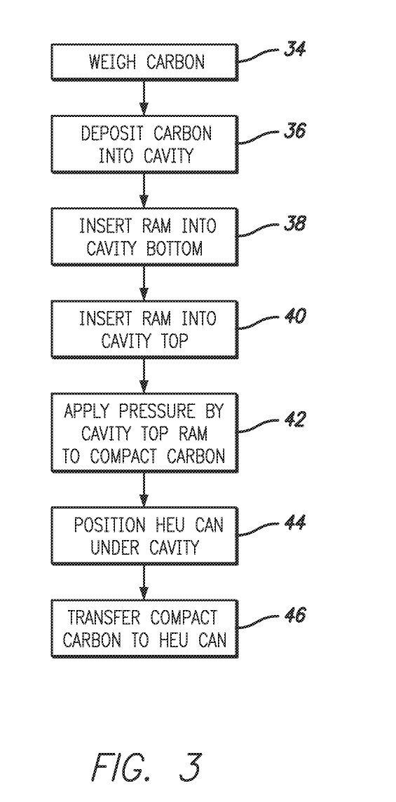

Referring now more specifically to FIG. 3, the process for accomplishing the compaction of the adsorbent material is set forth. The adsorbent material in FIG. 3 is referred to as carbon but it is to be understood that it is a combination of the activated carbon with the graphite and binder as above described. As is shown in FIG. 3 at 34, the first step is to weigh the adsorbent material so that the desired sufficient amount thereof is available for insertion into the cavity as above described. The amount of adsorbent material may vary depending upon the size of the HEU and the desired amount of cooling that is to be accomplished. As a result, the amount of adsorbent material can be empirically determined for each application. Once the adsorbent material is weighed, it is then deposited into the cavity as shown at 36. Once the adsorbent material is deposited into the cavity then the first ram is inserted into the bottom of the cavity and is inserted sufficiently far enough into the cavity to provide the desired expansion capability of the adsorbent material once it has been compacted and the rams are removed. After the ram is inserted into the cavity bottom shown at 38, then the second ram is inserted into the cavity top as shown at 40. Once this occurs, then sufficient pressure is applied particularly by the top ram which is inserted into the cavity to compact the adsorbent material such as shown at 42. As above indicated, the amount of pressure which is applied between the bottom ram and the top ram, particularly by applying pressure to the top ram, is to provide a force of approximately 17 tons to adequately compact the adsorbent material for each cavity. Once the compaction has occurred as illustrated at 42, the top and bottom rams are removed and as shown at 44 a HEU can is positioned underneath the cavity to receive the compacted adsorbent material. The compacted adsorbent material is then transferred from the cavity to the HEU can as shown at 46.

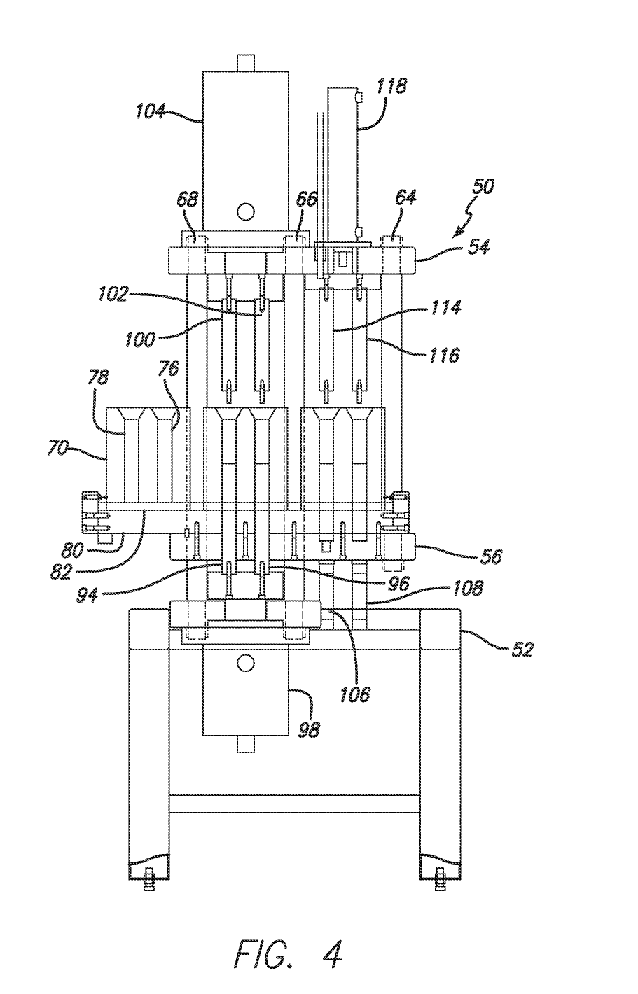

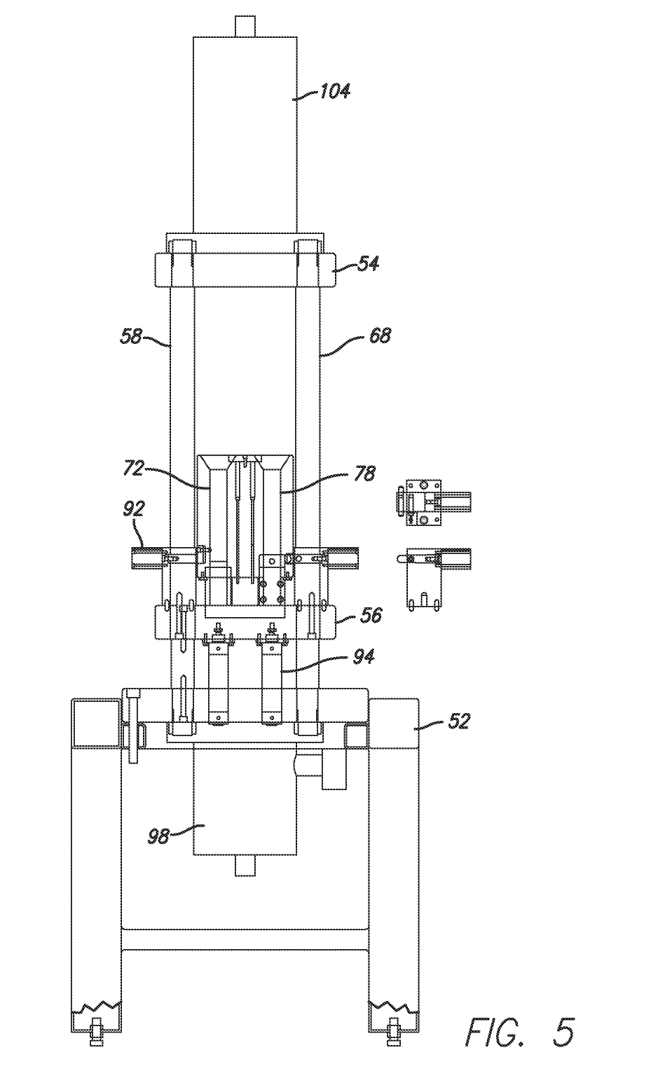

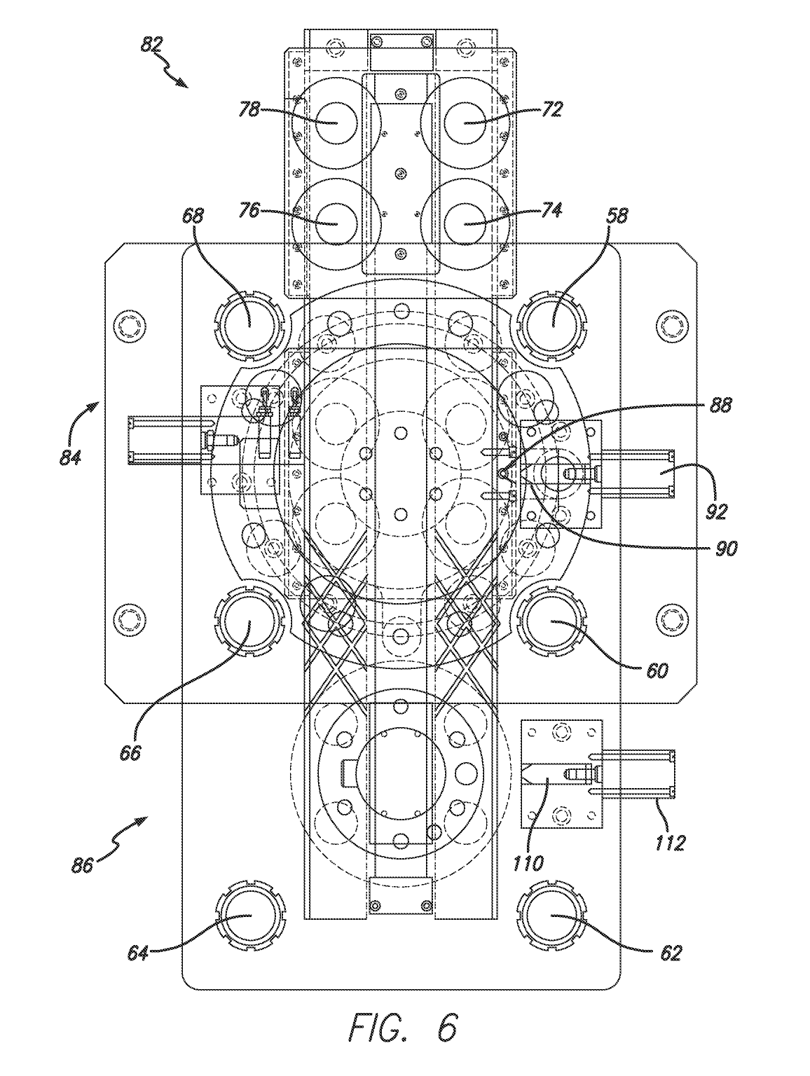

Referring now more particularly to FIGS. 4, 5 and 6, there is illustrated an apparatus which includes four cavities for accomplishing the desired compaction of the adsorbent material as above described. Although the apparatus as illustrated in FIGS. 4, 5 and 6 includes only four cavities, it should be understood by those skilled in the art that additional cavities can be provided so that more than four individual compactions of adsorbent material may be formed at a time. As will be described more fully in detail below, the apparatus as shown in FIGS. 4, 5 and 6 includes a loading station, a compacting station and a transfer station. The cavities are contained within a module or block which is transferred from station to station as the adsorbent material is loaded, then compacted and then transferred into the HEU can as above described in conjunction with the schematic representations of FIGS. 1 and 2 and the method as described in conjunction with FIG. 3.

The apparatus 50 as shown in FIGS. 4, 5 and 6 includes a supporting frame 52 upon which the apparatus 50 is mounted. The apparatus 50 includes cross members 54 and 56 which in turn support tie bars 58, 60, 62, 64, 66 and 68. The tie bars take all of the tensile load that is generated during the compaction process as will be described more fully hereinafter.

A slider block 70 defines four cavities 72, 74, 76 and 78 therein. It is into these cavities that the measured amount of the adsorbent material is loaded in the first step of the compacting process. The slider block 70 is mounted upon a support mechanism 80 in such a manner that it is transportable by movement on the support mechanism 80 from the loading station 82 to the compaction station 84 and after the compaction occurs to the transfer station 86. A skid plate 82 is positioned under the cavities 72 through 78 to prevent the adsorbent material from falling out of the cavities when the slider block 70 is moved from the loading station to the compaction station.

Once the cavity block has been moved to the compaction station 84, it is locked into appropriate position by a side lock cup 88 which receives a cone 90 activated by an air cylinder 92 to thereby maintain the cavity block in the desired position throughout the compaction process.

Once the cavity block is in the compaction station 84 and locked properly in place, the compaction cycle is started. This initiates the bottom rams, two of which are shown at 94 and 96, to move into the cavities from underneath as a result of hydraulic pressure which is generated by the system 98. As a result, the rams 94 and 96 (and two additional rams which are on the opposite side of the apparatus 50 as shown in FIG. 4) so that there are four rams which move underneath into the bottom part of the four cavities 72, 74, 76 and 78 to support the adsorbent material which has been loaded into the cavities as described above. After the bottom rams move up inside the cavities, then the top rams, two of which are shown at 100 and 102, (two additional top rams are on the opposite side of the apparatus 50 as shown in FIG. 4) will move downwardly under hydraulic pressure provided by the system 104 to enter the cavities 72 through 78 from above. The hydraulic systems 98 and 104 are such that the major part of travel of the rams is under low pressure and high speed but that the final portion of the travel of the rams is switched to a different pump which delivers low movement speed of the rams but very high pressure which creates the compaction forces which are needed. As above described, the adsorbent material deposited in the cavities is thusly compacted between the top and bottom rams by a force of approximately 17 tons on each cavity. Since there are four cavities in this embodiment, there will be an equivalent of approximately 68 tons of force applied. It will be understood by those skilled in the art that the various components of the apparatus 50 have to be constructed and sized so as to withstand these forces and the tensile stresses imposed on the tie bars. Although four cavities have been illustrated and described, it should be understood that more than four cavities may be utilized. When such is done, then additional stresses are created by the required 17 tons of force for each cavity and appropriate sizing of the components is accomplished to withstand the stresses, both bending and tensile, which are created. The compaction cycle time is triggered by a pressure sensor in the control system and allows the compaction time to extend for several seconds. Once the compaction time expires, then the hydraulic systems 98 and 104 extract the rams to remove them from the cavities both at the top and the bottom. When this occurs, the compacted carbon expands slightly in both longitudinal directions, but because of the cavities defined within the cavity block, the compacted carbon cannot expand laterally. What is provided to accommodate the expansion of the carbon is that the stroke on the bottom ram is approximately thirty millimeters into the bottom of the cavity. There will be an additional available space at the top of the cavity to permit expansion in that direction as well. As above indicated, the tie bars 58 through 68 in the apparatus take all of the tensile load so that there is no load on the cavity block slider.

After compaction of the adsorbent material occurs, the locking cone 92 is retracted from the locking cup 88 and the cavity block is then positioned along the mechanism 80 to the transfer station 86. When in this position HEU shells or cans are positioned directly underneath the cavity block. Two of these HEU shells are illustrated at 106 and 108 (it being understood that two additional HEU shells or cans will be positioned beneath the cavities on the opposite side from that shown in FIG. 4). When the cavity block has been moved into the transfer station 86, it will be locked in position by a locking cone 110 which is moved by an air cylinder 112 to engage the locking cup 88 to thus secure the cavity block in position in the transfer station. Once this occurs, additional hydraulic rams, two of which are shown at 114 and 116 in FIG. 4 (it being understood that two additional such rams are also positioned on the opposite side from that shown in FIG. 4), are activated by an additional hydraulic mechanism 118 to transfer the compacted carbon out of the cavities and into the HEU shells or cans as shown at 106 and 108. A small amount of force is applied to the adsorbent material by these rams once the compacted adsorbent material is in the HEU shells or cans to insure good surface contact between the compacted adsorbent material and the entire interior surface of the HEU shells for efficient heat transfer to properly cool the food or beverage contained within the containers within which the HEU's are mounted. It should be understood that the amount of force applied to the compacted adsorbent material is sufficiently small so that no damage is imparted to the HEU shells or to the compacted adsorbent material. After the rams 114 and 116 are retracted, the cavity block has the locking cone 110 retracted therefrom and the cavity block is then traversed back to the loading station 82 along the mechanism 80. The HEU cans which now contain the compacted adsorbent material are ejected by air cylinders positioned under paths directly below the shell cavities. The HEU cans containing the compacted adsorbent material are then transported to an additional area for being assembled into the containers in which the food or beverage to be cooled is to be housed. It will now be understood by those skilled in the art that once this occurs, the cycle as above described with regard to the apparatus 50 is repeated and this will then occur on a continuous basis to provide production capacity for generating HEU's.

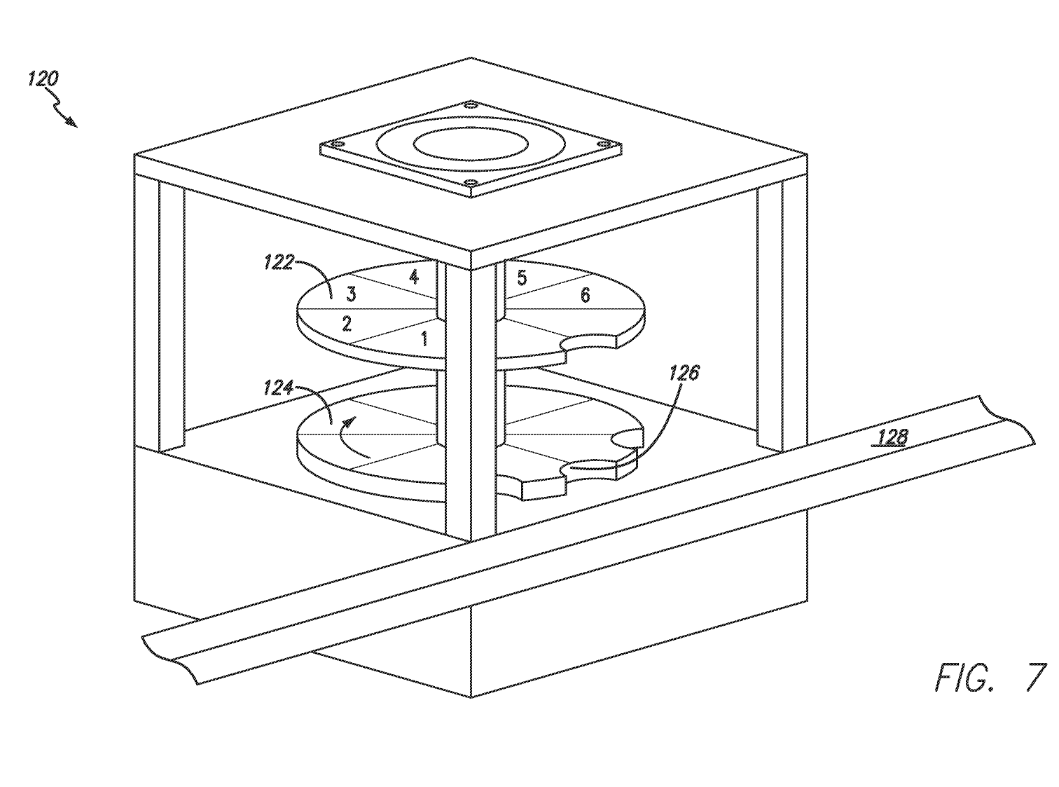

By referring now more particularly to FIG. 7, there is schematically illustrated an additional mechanism which can be utilized to obtain the desired compaction of the adsorbent material. As is therein shown, there is illustrated in schematic form a station in which there are positions defined by a pair of rotating circular members or plates 122 and 124 in which cavities as above described (but not shown in FIG. 7) are provided and as the plates 122 and 124 are rotated through the stations numbered 1 through 6 adsorbent material is inserted for example at station 1 into the cavity and the cavity is then rotated to station number 2 and in that position rams as above described will be inserted both below and above to compact the adsorbent material. These rams are then extracted and the cavity is rotated to station 3 where additional adsorbent material is inserted and then the plates 122, 124 are rotated to station 4 where additional compaction occurs and subsequently to station 5 where additional adsorbent material is inserted and then to station 6 where additional compaction occurs. Subsequent to the final compaction stage, the plates 122 and 124 are rotated to the final station shown at 126 where the compacted adsorbent material is then transferred from the cavity into an HEU can which is moved along the HEU feed 128 into the desired position and at that point the compacted adsorbent material is transferred into the HEU can and subsequently the HEU can is then extracted from the lower plate 124 and is transported to the desired station for further assembly as above described. Although three separate stations for loading the cavities with the desired amount of adsorption material and for compaction are shown, it should be understood that more or less stations can be utilized if a rotary system such as that shown in FIG. 7 in very brief schematic form is to be utilized.

There has thus been disclosed apparatus in various embodiments for compacting adsorbent material, preferably activated carbon with graphite and a binder, by placing the adsorbent material in a cavity formed in a cavity block and then providing pressure by way of hydraulically actuated rams to highly compact the adsorbent material and then to transfer the same into a HEU can for further assembly into the container for the food or beverage which is to be cooled at a later time.

1. Apparatus for compacting an adsorbent material comprising:
a module defining a plurality of cavities and sequentially movable from a loading station to a compaction station and to a transfer station;
a plurality of rams disposed at said compaction station positioned to engage adsorbent material disposed in said cavities to compact the adsorbent material; and
means at said transfer station or extracting compacted adsorbent material form said cavities.

2. Apparatus for compacting an adsorbent material as defined in claim 1 wherein said cavities have open ends and said rams include two rams for each cavity with one ram positioned to enter one end of a cavity and the other ram positioned to enter the other end of that cavity.

3. Apparatus for compacting an adsorbent material as defined in claim 2 which further includes a skid plate disposed beneath said module to prevent adsorbent material from falling out of the cavities as the module is moved from said loading station to said compaction station.

4. Apparatus for compacting an adsorbent material as defined in claim 2 wherein said rams exert a pressure on adsorbent material in each cavity of approximately 17 tons.

5. Apparatus for compacting an adsorbent material as defined in claim 4 which further includes a lock for securing said module in said compaction station throughout the time that said rams are compacting adsorbent material in said cavities.

6. Apparatus for compacting an adsorbent material as defined in claim 4 which further includes a first cross member positioned below said stations and a second cross member positioned above said stations, a plurality of tie bars extending between and connected to said first and second cross members to adsorb the tensile load created during the compaction of said adsorbent material.

7. A method of compacting adsorbent material comprising the steps of:
providing a block of material defining a plurality of cavities;
depositing a predetermined amount of an adsorbent material into each of said cavities;
applying a pressure of approximately 17 tons to said adsorbent material in each said cavity;
providing a heat exchange unit (HEU) can for each said cavity; and
transferring the compacted adsorbent material from said cavity to said HEU can.

8. A method of compacting adsorbent material as defined in claim 7 wherein the step of applying pressure is accomplished by inserting a ram mechanism into each said cavity.

9. A method of compacting adsorbent material as defined in claim 8 wherein said ram mechanism comprises a first ram inserted into one end of each cavity and a second ram inserted into the other end of each cavity.

10. A method of compacting adsorbent material as defined in claim 9 wherein the predetermined amount of said adsorbent material is determined by weighing the adsorbent material.
